(19) United States
(12) Patent Application Publication
(10) Pub. No.: US 2024/0338200 A1
(43) Pub. Date: Oct. 10, 2024

(54) PRODUCT UPDATE MANAGEMENT USING MOBILE DEVICE MANAGEMENT ACCOUNTS AND ROLE ACCOUNTS

(71) Applicant: Ivanti, Inc., South Jordan, UT (US)

(72) Inventors: Josh Howard, South Jordan, UT (US); Cal Romer, South Jordan, UT (US); Nick Krueger, New Brighton, MN (US); Jens Miltner, Frankfurt am Main (DE); Paul Keith Branton, Daresbury (GB); Micahel Stahulak, Salt Lake City, UT (US); Randy Parmer, Highland, UT (US); Zach Durtschi, Las Vegas, NV (US)

(73) Assignee: Ivanti, Inc., South Jordan, UT (US)

(21) Appl. No.: 18/628,597

(22) Filed: Apr. 5, 2024

Related U.S. Application Data
(60) Provisional application No. 63/494,744, filed on Apr. 6, 2023.
(60) Provisional application No. 63/607,472, filed on Dec. 7, 2023.

(51) Int. Cl. G06F 8/65

(52) U.S. Cl. CPC G06F 8/65

(57) ABSTRACT

A method of product update management in systems having product access restrictions associated with administrative credentials includes detecting that an operating system (OS) update is outstanding at an endpoint. The method includes communicating a request for an OS update to the endpoint and determining whether it is enrolled in a mobile device management (MDM) environment. If the endpoint is enrolled in the MDM environment, the method includes communicating a request for an MDM call to an MDM module of a management device. The MDM module includes authority to initiate the OS update. The method includes queuing and scheduling an OS update command with an MDM requester. The method includes communicating, by the MDM requester, an update command to a vendor agent of the endpoint. The method includes interfacing with a third party update service to retrieve an OS update and communicating with the OS to initiate installation the OS update.

### CROSS-REFERENCE TO RELATED APPLICATIONS

This application claims priority to and the benefit of U.S. provisional applications nos. 63/494,744, filed Apr. 6, 2023, and 63/607,472, filed Dec. 7, 2023, which are incorporated herein by reference in their entireties.

### FIELD

The embodiments described in this disclosure are related to automated endpoint product management, and in particular to systems and methods for implementation of product updates in a managed network that supports a mobile device management (MDM) environment.

### BACKGROUND

In enterprise networks and other managed networks, an endpoint refers to a computing device that is integrated into the network. In some managed networks, the endpoints are in communication with a management device, which is also included in the managed network. The management device may include a server device, for instance, which has visibility to operating parameters and state parameters of the endpoints. Based on information communicated between the management device and the endpoints, the management device may detect issues at the endpoints, deploy solutions to the endpoints, update software on the endpoints, troubleshoot issues at the endpoints, provision roles and security controls to the endpoints, etc.

One management operation of the managed networks is coordination and distribution of product updates. Sometimes this operation is referred to as patch or product update management. The updates or patches include code changes to products on the managed endpoints or some subset thereof. The products that are updated include software applications, software tools, operating systems, and the like. Distribution of the updates is important to ensure the products are properly functioning and to ensure security vulnerabilities are addressed.

In some circumstances, a vendor may limit access to products. For instance, the vendor may limit an ability to update the products during product update operations by requiring administrative credentials and a secure token to implement modifications of the products. The administrative credentials and the secure token may be provided to only a small subset of endpoints (e.g., two or three) in a managed network. Thus, remote product update operations may be prevented at a portion of endpoints that do not have access to the administrative credentials and the secure token. Additionally or alternatively, the product update operation may be centrally controlled via a mobile device management (MDM) service. The MDM service may not be implemented widely across the endpoints of a managed network. Thus, remote product update operations may be prevented at a portion of endpoints that are not directly managed by the MDM service. In these systems, product update operations, especially remote product update operations may be prevented or delayed, which may result in vulnerabilities to persist at the endpoints or may result in outdated versions of the products to remain at the endpoints. Accordingly, there is a need for a patch management system to initiate and implement product update operations in the endpoints subject to product update control related to MDM service and administrative credentials.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of product update management. The method may be implemented in systems having product access restrictions associated with administrative credentials. The method may include receiving an installation request for a product update to a product associated with a managed endpoint. The installation request may be generated and communicated by a remote management system. The method may include scanning the managed endpoint to ensure the product update is relevant to a version of the product installed at the managed endpoint. The method may include checking the availability of an existing role account. The existing role account enables a remediation operation. Checking availability of the existing role account may include accessing a secured data storage such as a keychain at the managed endpoint. In response to the existing role account being unavailable, the method may include obtaining the credentials of a user authorized to enable the remediation operation. The obtaining the credentials may include triggering a credentials request, which may occur in a role manager user interface. Additionally, the obtaining the credentials may include determining whether a user associated with the credentials is assigned a secure token and validating the credentials as being those of a user with administrative authority. The secure token may be associated with an administrative level of authority. Additionally, in response to the existing role account being unavailable, the method may include generating a new role account. The new role account may be configured to enable the remediation operation. Generation of the new role account may be enabled by the obtained credentials and may include a secured password. The new role account may include an administrator command, a user credential, an admin user credentials, other information, or combinations thereof. The method may include retrieving the new role account. The method may include decrypting the credentials from the retrieved role account. The method may include entering the credentials from the retrieved role account. The method may include executing the remediation operation to implement the product update at the managed endpoint.

A further aspect of an embodiment may include non-transitory computer-readable medium having encoded therein programming code executable by one or more processors to perform or control performance of one or more of the operations of the methods of product update management described above.

An additional aspect of an embodiment may include compute device comprising one or more processors and a non-transitory computer-readable medium having encoded therein programming code executable by one or more processors to perform or control performance of one or more of the operations of the methods of product update management described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2A depicts a block diagram of a first portion of an example automated MDM-based product update management process (MDM management process) that may be implemented in the operating environment 100 of FIG. 1;

FIG. 2B depicts a block diagram of a second portion of the MDM management process of FIG. 2A;

FIG. 2C depicts a block diagram of an example role account-based automated product update management process that may be implemented in the operating environment 100 of FIG. 1;

FIGS. 3A and 3B depict sequence diagrams of the MDM management process of FIGS. 2A and 2B;

FIG. 4 depicts an example remediation process based on role account generation that may be implemented in the operating environment of FIG. 1;

FIGS. 5A-5D are a flow chart of an example method of product update management;

FIGS. 6A and 6B are a flow chart of another example method of product update management;

FIG. 7 is a flow chart of an example method of obtaining credentials; and

FIG. 8 illustrates an example computer system configured for product update management in systems having product access restrictions,
all according to at least one embodiment described in the present disclosure.

### DESCRIPTION OF SOME EXAMPLE EMBODIMENTS

The embodiments described in this disclosure are related to automated endpoint product management, and in particular to systems for and methods for implementation of product updates in managed networks that support a mobile device management (MDM) environment.

For instance, some embodiments may be implemented in systems having product access restrictions associated with credentials. Updating products in managed endpoints (hereinafter, “endpoints”) in these systems may be difficult. For instance, to implement a product update, an administrator may have to input their credentials at the endpoint. Embodiments of the present disclosure implement a process by which the product update may be initiated at many if not all of the endpoints.

For instance, in some embodiments, a management device may initiate vulnerability scan of one or more of the endpoints. Based on the scan, the management device may create a vulnerability content, which includes a list of vulnerabilities present at the one or more endpoints and operations that may be implemented to remediate the vulnerabilities. In response to the vulnerabilities existing at a first endpoint, the management device may request an agent of the first endpoint to check in and download the vulnerability content. Additionally, the management device may request the agent to search locally on the endpoint for the vulnerabilities based on the vulnerability content. In some embodiments, the vulnerability content may include detection rules to perform the local search by the agent. The agent may report results of the local search to the management device. The results may indicate that one or more of the vulnerabilities actually exist at the first endpoint.

In response to the one or more vulnerabilities existing on the first endpoint, the management device may initiate a vulnerability remediation on the endpoint. The vulnerability remediation includes performance of an update operation in which a software is installed at the first endpoint and/or a setting at the first endpoint is modified. In some embodiments, an administrator may view the vulnerability detection results from the agent and finds an operating system (OS) vulnerability on the first endpoint. The management device may then request the agent to remediate the OS vulnerability on the first endpoint. The remediation may be based on the vulnerability content document. The agent may then decide, based on an agent configuration, how the remediation can be implemented. If the first endpoint is enrolled in a supported MDM environment, then the agent may perform or implement the OS remediation by requesting an MDM service to send an updated operating system command back to the first endpoint. If the device is not enrolled in the supported MDM environment, then the agent may check for the existence on the first endpoint of a role account with administrative privileges that is accessible to perform the OS remediation. With the role account, the agent may perform the OS remediation using built in OS management capabilities. If the first endpoint is not enrolled and the role account is not available, the first endpoint may generate an alert that is visible to a user of the first endpoint that indicates that an OS update is outstanding. The alert may be displayed at the first endpoint and may be combined with a user interface that may be implemented to enter administrative credentials. With the administrative credentials, the OS remediation may be implemented.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

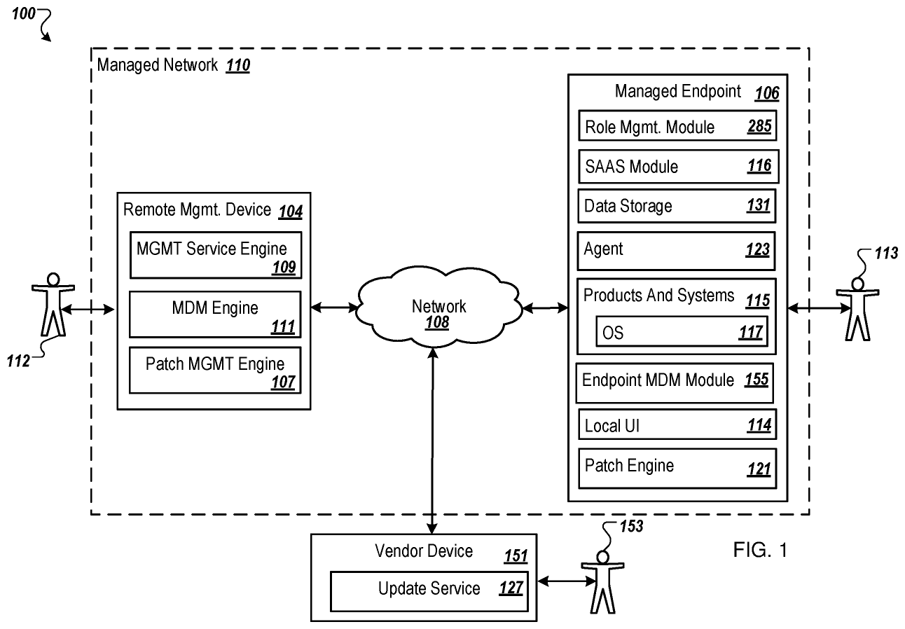

FIG. 1 is a block diagram of an example operating environment 100 in which some embodiments of the present invention may be implemented. The operating environment 100 may be configured for implementation of product update management of a managed endpoint 106 (hereinafter, “endpoint 106”). The endpoint 106 may be included in a managed network 110, which is operated or controlled by a remote management device 104 (in the Figures “remote mgmt. device 104”). The remote management device 104 may be configured to implement management functions such as patch management, role management, product or application management, access management, etc.

In the depicted embodiment, the remote management device 104 may be configured to implement patch management relative to the endpoint 106. In some embodiments of the present disclosure, particular credentials and/or a secure token may be necessary to implement product updates. For instance, requiring the particular credentials and/or the secure token may reduce a likelihood that products and systems 115 (hereinafter, product or products 115) at the endpoint 106 are incorrectly modified. Moreover, requiring the credentials and/or the secure token may ensure that an administrator 112 better controls operations and system configuration of the endpoint 106. However, the requirement of the credentials and/or the secure token may prevent or incumber remote product update implementation in the managed network 110.

For instance, in systems that do not require the secure token, the remote management device 104 may interface with a patch engine 121 at the endpoint 106 and cause a product update to be installed. However, in the endpoint 106 of FIG. 1, without credentials of the administrator 112 and a secure token assigned to the administrator 112, the product update cannot be remotely initiated at the endpoint 106. Instead, when remote initiation of the product update is attempted, an error may be generated and the products 115 may remain unpatched. Unpatched products and systems introduce vulnerabilities to the managed endpoint and the managed network 110. Accordingly, some embodiments of the present disclosure utilize a multi-operation update process in which an agent 123 on the endpoint 106 determines whether the endpoint 106 is deployed in a managed network 110 that supports an MDM environment. For instance, in the depicted embodiment the remote management device 104 includes an MDM engine 111. The MDM engine 111 enables coordination of the credentials and authorization required to implement a product update operation. The MDM engine 111 may then coordinate communications necessary for an update service 127 of a vendor device 151 to provide the update to the endpoint 106. If the managed network 110 does not support an MDM environment, the remote management device 104 and/or the endpoint 106 may generate a role account configured to make the secure token and administrative credentials available. The role account may enable access to the secure token and the administrative credentials, which may enable a remediation operation to address outstanding product updates. The role account may be protected by a secured password and stored in a secured data storage 131 such as a password management system on the endpoint 106.

Additionally, generation of the role account may be unavailable and the endpoint 106 may not be implemented in the MDM environment. In these circumstance, a user interface may be displayed that enables entry of the administrative credentials.

In these and other embodiments, some or all of the multi-operation update process may be a background process, which may minimize or eliminate visibility or involvement of the user 113, which may maintain security and limited access to administrative credentials at the endpoint 106. These and other embodiments enable secured, remote management of credentials and/or secure token and enable product management in systems that require entry of such information prior to product update implementation.

These embodiments of the present disclosure provide a technical improvement to conventional patch management systems. Implementation of the multi-operation update process enables product update remediation operations that would otherwise be prevented. Furthermore, the multi-operation update process enables remote update management at the endpoint 106 while maintaining minimal access to the administrator credentials.

The operating environment 100 of FIG. 1 includes the endpoint 106, the remote management device 104, and a vendor device 151. The endpoint 106, the remote management device 104, and a vendor device 151 are configured to communicate data and information via a network 108. Each of these components are introduced in the following paragraphs.

The network 108 may include any communication network configured for communication of signals between the components (e.g., 104, 151, and 106) of the operating environment 100. The network 108 may be wired or wireless. The network 108 may have configurations including a star configuration, a token ring configuration, or another suitable configuration. Furthermore, the network 108 may include a local area network (LAN), a wide area network (WAN) (e.g., the Internet), and/or other interconnected data paths across which multiple devices may communicate. In some embodiments, the network 108 may include a peer-to-peer network. The network 108 may also be coupled to or include portions of a telecommunications network that may enable communication of data in a variety of different communication protocols.

In some embodiments, the network 108 includes or is configured to include a BLUETOOTH® communication network, a Z-Wave® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 108 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The vendor device 151 may include or implement a hardware-based computer device configured to communicate data and information with the other components of the operating environment 100 via the network 108. The vendor device 151 may be associated with a vendor 153 of one or more of the products 115. The vendor 153 may generate product updates for the one or more products 115, which may be available at or communicated via an update service 127.

The update service 127 may enable installation of updates to the products 115 and modifications to the products 115. For instance, the update service 127 may receive sufficient information related to the endpoint 106 to communicate or enable access to a product update.

In addition, the vendor device 151 may generate update metadata that may be used to implement and/or install the product update at the endpoint 106. In some embodiments, the product update process may involve an update catalog. The update catalog may be used to determine which of the products 115 have an outstanding update.

The vendor 153 may restrict access to the products 115 at the endpoint 106. For instance, the vendor 153 may restrict modifications to the products 115 (e.g., installation of product updates) to administrators such as the administrator 112 and MDM environments. Limiting modifications to the products 115. Additionally, the vendor 153 may confirm the identity of the administrators by assignment of a secure token to the administrators. Requiring the secure token may reduce the likelihood that the products 115 are incorrectly updated or otherwise incorrectly modified. Accordingly, the user 113, who is not an administrator, may not be able to initiate modifications to the products 115. Additionally, the remote management device 104 may not be able to initiate modifications to the products 115 remotely.

An example of the vendor 153 may be Apple® in some embodiments. In these and other embodiments, the products 115 may include macOS®, the AppStore®, FaceTime®, etc. Additionally or alternatively, the endpoint 106 may be an Apple hardware component such as a Mac® computer (e.g., MacBook, etc.), an iPhone®, iPad®, etc. Apple may require administrative authority or an MDM environment to implement product updates for the products 115 that are produced by Apple.

The endpoint 106 and the remote management device 104 may be a part of the managed network 110. The managed network 110 is implemented to enable provision of management services to the components of the managed network 110 by the remote management device 104. Part of the management services provided to the endpoint 106 may include operations related to the product updates of products 115 using the multi-operation update process described in the present disclosure such as managing secure tokens and credentials as well as generation of role accounts based thereon.

The managed network 110 may be at least partially implemented remotely. For instance, the managed network 110 may be part of a SAAS and/or cloud-based system, which manages multiple groups of endpoints such as the endpoint 106. In these and other embodiments, the endpoint 106 may be one endpoint of multiple endpoints that are managed by the remote management device 104.

In some embodiments, the endpoint 106 is enrolled in the managed network 110. As part of an enrollment process, the patch engine 121 and/or an agent 123 may be loaded to the endpoint 106. Once enrolled, communication of data, information, commands, notifications, or combinations thereof between the endpoint 106 and the remote management device 104 may occur. The managed network 110 may be associated with an enterprise, a portion of an enterprise, a government entity, or another entity or set of devices (e.g., 106).

The remote management device 104 may include a hardware-based computer system that is configured to communicate with the other components of the operating environment 100 via the network 108. The remote management device 104 may be associated with the administrator 112. The administrator 112 may be an individual, a set of individuals, or a computer system that interfaces with the remote management device 104 or otherwise has administrative authority in the managed network 110. The administrator 112 may be assigned a secure token by the vendor 153. The secure token may verify and identify the administrator 112. Additionally, the administrator 112 may be identified as a volume owner. The volume owner indicates that the administrator 112 has claimed a configuration role relative to the endpoint 106.

In some embodiments, the administrator 112 may provide input to the remote management device 104. The input provided by the administrator 112 may form the basis of one or more computing processes performed by the remote management device 104. In some embodiments, supplied credentials may be invalid and/or a secure token may not be functional. In response, the administrator 112 may take actions to facilitate validation of the credentials and/or access the secure token.

The remote management device 104 may include the management service engine 109, an MDM engine 111, and a patch management engine 107. The management service engine 109 is configured to perform management operations relative to the endpoint 106. For instance, the management service engine 109 may discover and control the products 115 on the endpoint 106. In addition, the management service engine 109 may perform role management and security settings at the endpoint 106. For instance, the management service engine 109 may determine privileges of the user 113, which may include credentials management.

In some embodiments, the management service engine 109 may communicate with the SAAS module 116 of the endpoint 106. Credentials entered or received at the remote management device 104 may be distributed to the SAAS module 116 or the agent 123 of the endpoint 106.

The patch management engine 107 may be configured to manage product updates at the endpoint 106 and throughout the managed network 110. In some embodiments, the patch management engine 107 may ingest and process update information produced by the vendor device 151. The patch management engine 107 may generate patch packages and vulnerability content at the endpoint 106. The patch packages and/or the vulnerability content that may be communicated to the endpoint 106. As described elsewhere herein, based on the patch packages, the agent 123 or another component of the endpoint 106 may implement a remediation operation or a product update operation to update one or more of the products 115.

The product update management implemented by remote management device 104 may enable product updates such as software patches and code changes to be accessed, consumed, and distributed to the endpoint 106. The product updates may be implemented at the endpoint 106. Implementation of the product updates at the endpoint 106 include modification to computer code, programming code, or computer-executable instructions of at least one program that is included in the products 115.

The endpoint 106 may include a hardware-based computer system that is configured to communicate with the other components of the operating environment 100 via the network 108. The endpoint 106 may include any computer device that may be managed by the remote management device 104 and/or have been enrolled in the managed network 110. The endpoint 106 includes devices that are operated by the personnel and systems of an enterprise or store data of the enterprise. The endpoint 106 might include workstations of an enterprise, servers, data storage systems, printers, telephones, internet of things (IoT) devices, smart watches, sensors, automobiles, battery charging devices, scanner devices, etc. The endpoint 106 may also include virtual machines, which may include a portion of a single processing unit or one or more portions of multiple processing units, which may be included in multiple machines.

The endpoint 106 may be associated with the user 113. The user 113 may be an individual, a set of individuals, or a computer system that interfaces with the endpoint 106. In some embodiments, the user 113 may provide input to the endpoint 106. The input provided by the user 113 may include credentials information. For example, the user 113 may provide user input to the local UI 114. In the embodiment of FIG. 1, the user 113 may be a non-administrative user.

The endpoint 106 includes the products 115. The products 115 may include applications of any kind or type. Some examples of the products 115 may include software applications, enterprise software, an operating system 117, and the like. As described above, modification of at least a portion of the products 115 may be limited or prohibited by non-administrative users or users without access to administrative authority.

The endpoint 106 may include the data storage 131, a SAAS module 116, a local user interface (UI) 114, the agent 123, an endpoint MDM module 155, a role management module 285, and a patch engine 121, or some combination thereof.

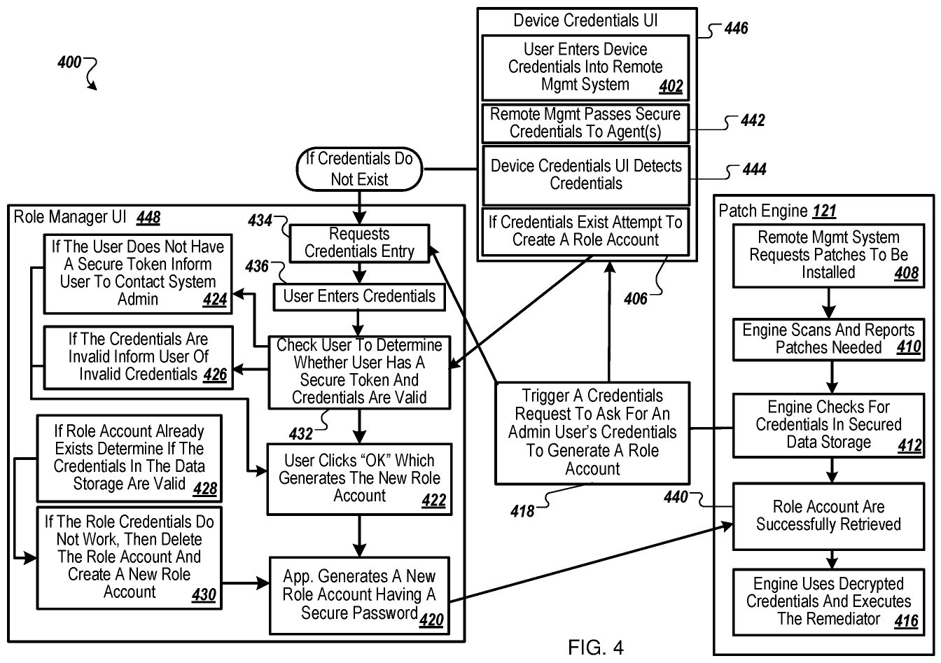

The data storage 131 may be an example of memory such as memory 812 of FIG. 4 in some embodiments. Additionally or alternatively, the data storage 131 may be a password management system such as Apple Keychain, which persists in a folder on the endpoint 106.

The patch engine 121 may periodically pull data and information related to the products 115 and/or to the endpoint 106. The patch engine 121 may communicate the data and information to the remote management device 104 to perform the multi-operation update process or portions thereof. Additionally or alternatively, the patch engine 121 may receive commands and instructions from the management service engine 109 and/or a patch management engine 107. Received commands may be implemented locally at the endpoint 106. Additionally, the patch engine 121 may at least partially implement the update processes and remediation processes described in the present disclosure.

To implement the update at the endpoint 106, the patch management engine 107 may communicate a request for an OS update to the endpoint 106. The agent 123 may determine whether the endpoint 106 is enrolled in an MDM environment. For instance, the agent 123 may access information from the MDM engine 111 that indicates that the MDM environment is supported. In response to a determination that the endpoint 106 is enrolled in the MDM environment, the agent 123 may communicate a request for an MDM call to the MDM engine 111. The MDM engine 111 may include authority to initiate the update at the endpoint 106.

The MDM engine 111 may generate an update command, which may be communicated to the endpoint MDM module 155. Based on the update command, the endpoint MDM module 155 may interface with the update service 127 to retrieve the product update to address the vulnerability at the endpoint 106. The agent 123 and the endpoint MDM module 155 may communicate with the OS 117 or the product 115 to initiate a product update operation. The product update operation is implemented to modify the OS 117 or the product 115 at the endpoint 106 to install the product update.

The endpoint MDM module 155 or the agent 123 may communicate an update status to the MDM engine 111. The update status may include a success message or an error message of the product update operation. Additionally, the endpoint MDM module 155 may request an inventory synchronization, which may communicate current versions of the products 115 to the MDM engine 111 and one or more other systems that monitor the endpoint 106.

In response to a determination that the endpoint 106 is not enrolled in the MDM environment, the agent 123 may initiate generation of a role account, which may enable access to the credentials that enable remediation of the outstanding vulnerability.

In some embodiments, the SAAS module 116 may enable the user 113 of the endpoint 106 to interface with the management service engine 109. For instance, the user 113 may provide input via the local UI 114. The input may be communicated to the management service engine 109 via the SAAS module 116 in some implementations. In some embodiments, credentials may be input to the local UI 114. The credentials may be communicated to the management service engine 109.

The role management module 285 may be configured to generate role accounts. The role accounts may provide a privilege to a group of users or endpoints (e.g., 106). The role accounts may be generated for one or more purposes. For instance, in the embodiments of this disclosure, the role accounts may be generated to enable remediation operations on the endpoint 106. In particular, the role account may provide a privilege to make a modification to one or more of the products 115 to install a product update.

In some embodiments, the patch management engine 107 may communicate an installation request to the endpoint 106. The installation request may indicate that the OS 117 or another of the products 115 includes a vulnerability or is otherwise out of date. Additionally, the patch management engine 107 and the agent 123 may determine that there is an update that has been developed by the vendor 153. The endpoint 106 may receive the installation request. For instance, the SAAS module 116 and/or the patch engine 121 may receive the installation request. The patch engine 121 may scan the endpoint 106. A scan performed by the patch engine 121 may be based on the installation request. For instance, the installation request may include data or metadata related to the product update that indicates which products are applicable to the product update.

The scan may be configured to ensure the product update of the installation request is relevant to at least one of the products 115 of the endpoint 106. For instance, the scan may ensure the product updates are applicable to a version of the product installed at the endpoint 106. Responsive to the product update being relevant to at least one of the products 115, the patch engine 121 may check availability of an existing role account that enables a remediation operation at the endpoint 106 or at the relevant product.

In conventional systems, in response to the credentials being unavailable, an error may be generated, and the product update may not be distributed and implemented at the endpoint 106. Embodiments of the present disclosure instead perform operations to obtain credentials and a secure token and then generate a role account based thereon that enables remediation operations.

For instance, the patch engine 121 may obtain the credentials of a user authorized to enable the remediation operations such as the administrator 112. In some embodiments, the patch engine 121 may trigger a credentials request. The credentials request may be triggered in the local UI 114 or in another UI into which credentials may be entered. The credentials may be validated, and it may be determined whether the secure token is associated with the authorized user. The role management module 285 may generate a role account. The credentials and/or the secure token may enable generation of the role account. In some embodiments, the role account may include a secured password. The role account is configured to enable the remediation operation. The role account may be stored in the data storage 131.

Generation of the role account may be a background process. For instance, the user 113 may not be aware of the role account generation. Moreover, the user 113 may not have visibility or access to the secured password of the role account. Accordingly, the user 113 may only be aware of entry of the credentials (if necessary, e.g., when an existing role account is not available). Otherwise, the user 113 may be unaware that the role account is being used to implement remediation processes at the endpoint 106.

The patch engine 121 may retrieve the role account from the role management module 285 or the data storage 131. The patch engine 121 may decrypt the credentials from the retrieved role account. The patch engine 121 may enter the decrypted credentials and execute the remediation operation to implement the product update.

In response to a determination that the endpoint 106 is not enrolled in the MDM environment and inability to generate the role account, the agent 123 may generate an alert, which may be displayed to the user 113. The alert may communicate to the user 113 that an update to the OS 117 or the product 115 is outstanding. The alert may include a user interface implemented to enable entry of administrative credentials to enable remediation operation.

In the described embodiment, certain operations are attributed to the agent 123, the endpoint MDM module 155, the patch engine 121, the role management module 285, the MDM engine 111, or some combination thereof. In some embodiments, the operations may be distributed in another way between the endpoint 106, the remote management device 104, or another endpoint 106, or components thereof. For instance, the endpoint 106 or the remote management device 104 may perform all, none, or some of the operations described above.

The patch engine 121, the SAAS module 116, the management service engine 109, the patch management engine 107, the role management module 285, the MDM engine 111, the endpoint MDM module 155, the agent 123, the products 115, and components thereof (collectively environment modules) may be implemented using hardware including a processor, a microprocessor (e.g., to perform or control performance of one or more operations), a field-programmable gate array (FPGA), or an application-specific integrated circuit (ASIC). In some other instances, the environment modules may be implemented using a combination of hardware and software. Implementation in software may include rapid activation and deactivation of one or more transistors or transistor elements such as may be included in hardware of a computing system (e.g., the endpoint 106 or the remote management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more vendor devices 151, one or more remote management devices 104, two or more managed endpoints 106, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers. For example, in some embodiments, the remote management device 104 and the vendor device 151 may be a single server, a set of servers, a virtual device, a virtual server, one or more computer programs which manages access to computing resource or services, a cloud-based network of servers. In these and other embodiments, the remote management device 104 and operations attributed thereto may be spread over two or more cores, which may be virtualized across multiple physical machines.

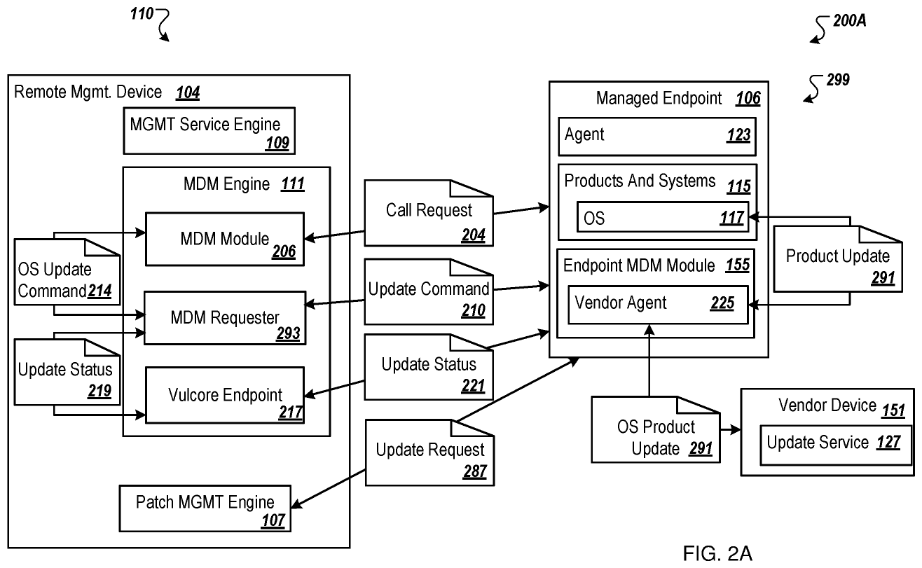

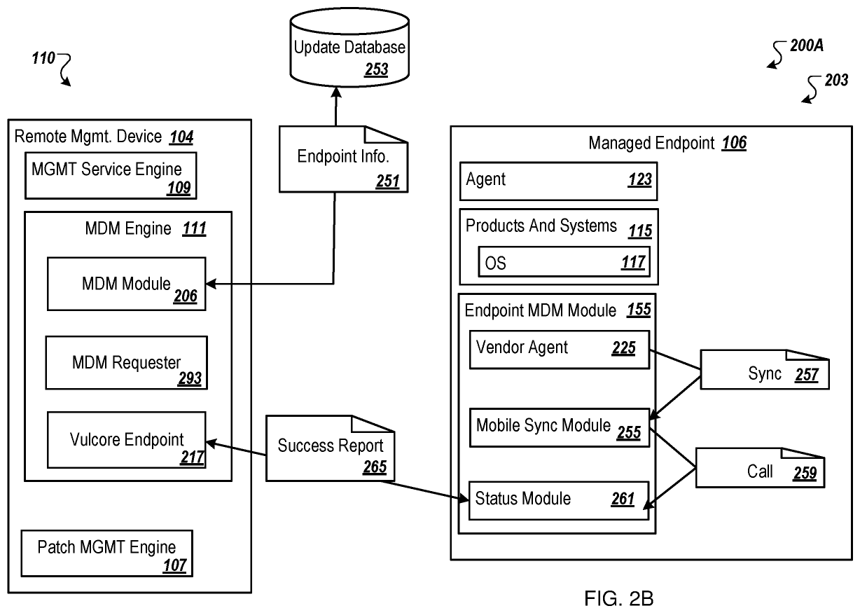

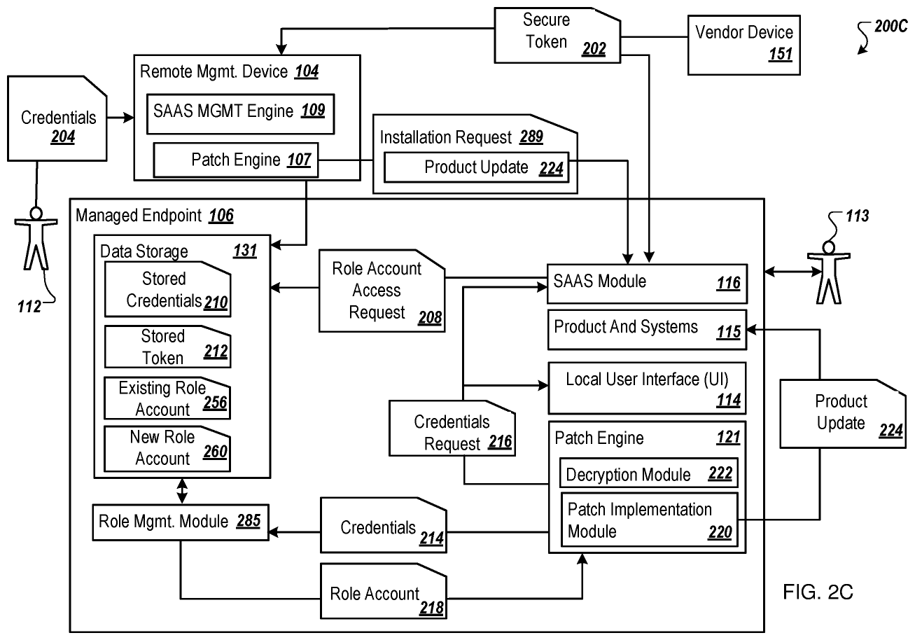

FIG. 2A depicts a block diagram of a first portion 299 of an example automated MDM-based product update management process (MDM management process) 200A that may be implemented in the operating environment 100 of FIG. 1 or another suitable environment. The embodiment of FIG. 2A includes one or more of the components (e.g., 104, 111, 285, 106, 151, etc.) described with reference to FIG. 1. Although not depicted in FIG. 2A, communication of data and information may be via a network such as the network 108.

The MDM management process 200A may be implemented in systems having product access and modification restrictions. Accordingly, the MDM management process 200A may be configured to interface with the MDM engine 111 to enable the remediation operation at the endpoint 106. The MDM management process 200A may be part of a multi-operation update process. The MDM management process 200A may be implemented with one or more of the processes described in with reference to FIGS. 2B-4.

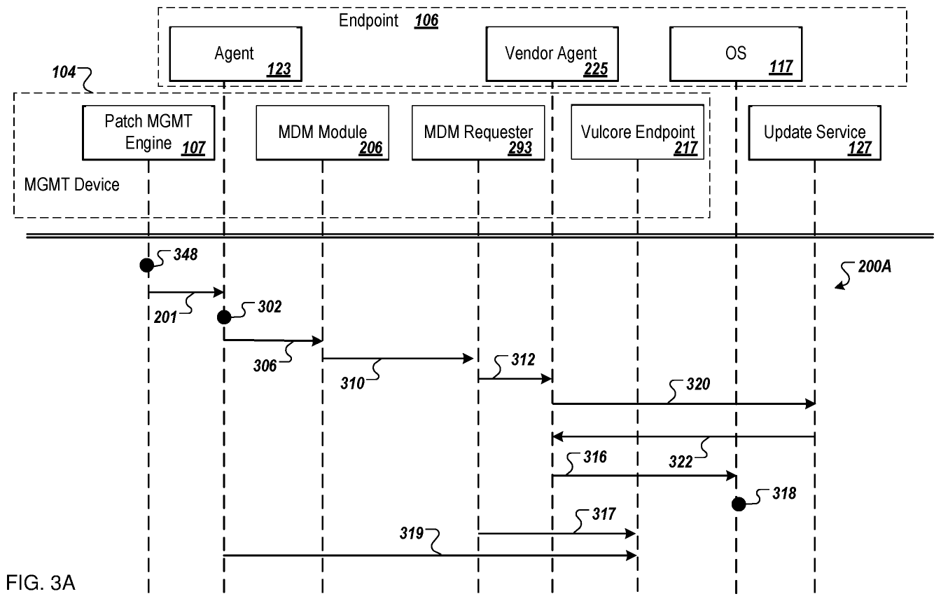

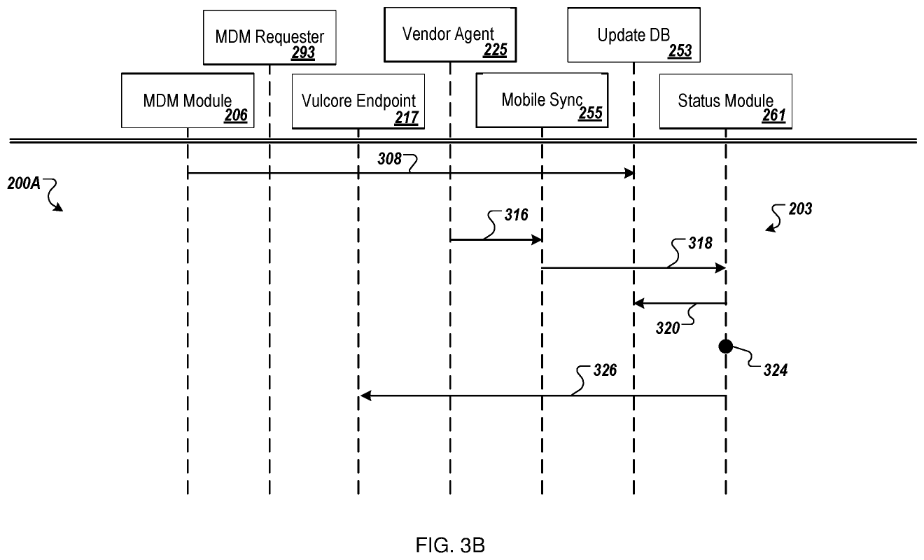

The MDM management process 200A of FIG. 2A is described with combined reference to FIG. 3A, which also depicts the MDM management process 200A as a sequence diagram implemented by the components of FIG. 2A. The MDM management process 200A may begin with the patch management engine 107 detecting that an OS update is outstanding (step 348) at an OS 117 at the endpoint 106. For instance, the vendor device 151 may publish a document indicating that a vulnerability exists in the OS 117 or may publish a newer or updated version of the OS 117. The patch management engine 107 may generate vulnerability content that is communicated to the agent 123 of the endpoint 106. Based on the vulnerability content, the agent 123 may determine whether the vulnerability content is applicable at the endpoint 106. The agent 123 may communicate to the patch management engine 107 a response that indicates the vulnerability exists or there is an outstanding update at the endpoint 106.

The patch management engine 107 may communicate a request 287 (in FIG. 2A, “update request 287”) for an OS update at the endpoint 106 (step 301). The request 287 may be communicated to the agent 123. The request 287 may include metadata, instructions, and information related to the OS update and/or to the vulnerability.

The agent 123 may receive the request 287 and determine whether the endpoint 106 is enrolled in the MDM environment (step 302). For example, the agent 123 may communicate with the MDM engine 111 or some component thereof, which indicates that the endpoint 106 is enrolled in the MDM environment controlled or operated by the remote management device 104.

In response to a determination that the endpoint 106 is enrolled in the MDM environment, the agent 123 may communicate (step 306) a request for an MDM call (in FIG. 2A, “Call Request”) to the MDM module 206 of the MDM engine 111. The MDM module 206 includes authority to initiate the OS update at the endpoint 106 in the managed network 110.

The MDM module 206 queues and schedules an OS update command with the MDM requester 293 (step 310). The MDM requester 293 communicates an update command to the vendor agent 225 of the endpoint 106 (step 312). The vendor agent 225 may be an additional agent at the endpoint 106 that is configured to communicate with the vendor device 151. The vendor agent 225 interfaces (step 320) with the update service 127, such as an Apple update service, and retrieves (step 322) an OS product update 291. The vendor agent 225 communicates with the OS 117 to initiate a product update operation (step 316). The product update operation is implemented to modify the OS 117 at the endpoint 106 (step 318).

The MDM requester 293 communicates an update status 219 to the vulcore endpoint 217 (step 317). The vulcore endpoint 217 is a virtual location on the remote management device 104. The vulcore endpoint 217 may interface with the patch management engine 107 to identify and remediate vulnerabilities at the endpoint 106. The agent 123 may also communicate a success or an error message (in FIG. 2A, “status update”) to the vulcore endpoint 217 (step 319). The vulcore endpoint 217 may accordingly receive information that a command to remediate the vulnerability was sent and whether or not it was implemented at the endpoint 106.

FIG. 2B depicts a block diagram of a second portion 203 of the MDM management process 200A of FIG. 2A. FIG. 2B includes one or more of the components (e.g., 104, 111, 285, 106, 151, etc.) described with reference to FIGS. 1 and 2A. Although not depicted in FIG. 2B, communication of data and information may be via a network such as the network 108. The second portion 203 of the MDM management process 200A includes a set of communication operations to ensure status of the OS product update 291 is reflected throughout the managed network 110. The second portion 203 of the MDM management process 200A of FIG. 2B is described with combined reference to FIG. 3B, which also depicts the second portion 203 of the MDM management process 200A as a sequence diagram implemented by the components of FIG. 2B.

The second portion 203 may begin by the MDM module 206 communicating endpoint information 251 regarding the endpoint 106 (step 308). For instance, an endpoint identifier and other information related to the endpoint 106 may be communicated to an update database 253.

Additionally, the vendor agent 225 may request an inventory synchronization 257 with a mobile sync module 255 of the endpoint 106 (step 316). The mobile sync module 255 may communicate a call 259 with a current version number of the OS update to a status module 261 (step 318). In addition, the status module 261 may communicate the status of the OS 117 (or another product 115) at the endpoint 106 to the update database 253 (step 320). The update database 253 may accordingly have the information related to the endpoint 106 and the status of the OS 117 and the other products 115 following a synchronization operation. The status module 261 may check a version of the OS 117 at the endpoint 106 (step 324). For instance, the status module 261 may ensure a version of a pending OS update includes an equal or lower version number than a current version at the endpoint 106. The status module 261 may communicate a success report 265 to the vulcore endpoint 217 (step 326).

FIG. 2C depicts a block diagram of an example role account-based automated product update management process (role account management process) 200B that may be implemented in the operating environment 100 of FIG. 1 or another suitable environment. The embodiment of FIG. 2C includes one or more of the components (e.g., 104, 111, 285, 106, 151, etc.) described with reference to FIG. 1. Although not depicted in FIG. 2C, communication of data and information may be via a network such as the network 108.

The role account management process 200B may be implemented in systems having product access and modification restrictions and that are not enrolled in an MDM environment. For instance, to access and to modify one or more of the products 115, administrative credentials and/or a secure token may be necessary. For instance, without the administrative credentials and/or the secure token, a remediation operation may be prevented. Accordingly, the role account management process 200B may be configured to provide access to the administrative credentials and/or the secure token such that the remediation operation may be performed at the endpoint 106.

The role account management process 200B may begin by the vendor device 151 providing a secure token 202 to the remote management device 104 and/or the endpoint 106. The secure token 202 may be assigned to an administrator such as the administrator 112. The secure token 202 may include a digital token that enables a two-factor authentication. In some embodiments, the secure token may include a wrapped version of key encryption key, which may be protected by a password of the administrator to whom the secure token 202 is assigned. The secure token 202 may be stored at the remote management device 104 and/or the data storage 131 as the stored token 212.

The role management module 285 may generate an existing role account 256. Generation of the existing role account 256 may be enabled by entry of the stored token 212 and credentials 204 provided by the administrator 112. For instance, administrator 112 may communicate the credentials 204 to the remote management device 104, which may be communicated to the endpoint 106 and stored in the data storage 131 as stored credentials 210. The existing role account 256 may be generated to enable remediation operations at the endpoint 106. The existing role account 256 may be formatted similarly to later role accounts generated by the role management module 285. In some embodiments, the existing role account 256 may be stored on the remote management device 104 such that it is accessible by managed endpoints of a managed network such as the endpoint 106.

The patch management engine 107 may communicate an installation request 289 to the endpoint 106. The installation request 289 may be generated in response to the vendor device 151 producing a product update 224 that may be relevant to at least one of the products of the products 115 on the endpoint 106. The product update 224 may include version update or a patch update for instance. The endpoint 106 may receive the installation request 289. In some embodiments, the installation request 289 may be received by the SAAS module 116 or the patch engine 121. After the installation request 289 is received, the patch engine 121 may scan the endpoint 106. The scan of the endpoint 106 may review the products 115 to ensure the product update 224 of the installation request 289 is relevant to at least one product of the products 115. For instance, the scan may ensure that the product update 224 applies to a particular version of the product installed at the endpoint 106.

If the scan indicates that the product update 224 indeed applies to one of the products 115, then the patch engine 121 may check for availability of the existing role account 256 that enables a remediation operation to install the product update 224.

There are at least three possible results of the check for the availability of the credentials. A first result is that the existing role account 256 is available at the data storage 131. In these circumstances, the patch engine 121 may perform the remediation operation to install the product update 224 in the product 115 to which it applies. This first result may occur when the user 113 is authorized to modify the products 115 (e.g., the user 113 has administrative credentials) or when the existing role account 256 was previously generated for the endpoint 106.

A second result may occur when the credentials are not available at the endpoint 106. This second result may occur in circumstances in which the existing role account 256 has not been generated yet. For instance, the stored token 212 and/or the stored credentials 210 may not have been communicated or otherwise entered into the endpoint 106 and the user 113 does not have administrative authority. The patch engine 121 may check for the existing role account 256 in the data storage 131 by communicating a message that includes a role account access request 208. In some embodiments, the role account access request 208 may include a “get” command. A failure of the get command may indicate that the existing role account 256 is not available.

In these and other circumstances, the patch engine 121 may obtain the credentials 204 of the administrator 112 or another user who is authorized to enable the remediation operation. In these and other embodiments, a credentials request 216 may be triggered. The credentials request 216 may be communicated to the local UI 114. The credentials request 216 may cause display of a UI into which credentials of the administrator 112 (e.g., the credentials 204) may be entered.

In some embodiments, the credentials 204 may be stored at the data storage 131 or may be otherwise available via the remote management device 104. In these and other embodiments, the credentials 204 may be entered into or accessed by the role management module 285. For instance, the SAAS module 116 may relay the credentials request 216 to the remote management device 104. The remote management device 104 may provide the credentials 204 responsive to the credentials request 216. Additionally or alternatively, the credentials request 216 may be communicated to a UI of the administrator 112 having the authority to modify the products 115 at the endpoint 106. The administrator 112 may provide as input the credentials 204.

Responsive to the credentials request 216, credentials (e.g., 204 or 214) may be entered or otherwise accessed. For instance, the user 113 may enter the credentials 204 (e.g., username and password) into the local UI 114. Alternatively, another user or the administrator 112 may enter the credentials 204 into the local UI 114 or another local UI at another managed endpoint.

Entered credentials may be communicated to the role management module 285. For instance, in FIG. 2C, credentials 214 may be communicated from the endpoint 106 to the role management module 285. Credentials entered into another managed endpoint may also be similarly communicated to the role management module 285. The role management module 285 may determine whether a user associated with the received credentials includes or is associated with a valid secure token (e.g., the secure token 202) and may validate the received the user associated with the credentials is an administrator. For instance, the role management module 285 may determine whether the user associated with the credentials is a volume owner and has been designated as having an administrative authority relative to the endpoint 106.

Responsive to the received credentials being those of an administrator, the role management module 285 may generate a new role account 260. Generation of the new role account 260 is enabled by the obtained credentials (e.g., 214). For instance, the obtained credentials are accepted as evidence of administrative authority involved in role account generation. The new role account 260 may be separate and/or different from the existing role account 256. The new role account 260 is configured to enable the remediation operation at the endpoint 106. Additionally, the new role account 260 may include reference to credentials of the user 113, credentials of the administrator 112, a role account identifier, a secured password, other information, or some combination thereof.

In some embodiments, instructions to generate the new role account 260 may be formatted as depicted in a first example role account generation instruction:

sudo sysadminct1−addUser “AgentName”−roleAccount−UID<id>−GID<gid>−password<pass>interactive.

The first example role account generation instruction includes Apple commands “sudo” and “sysadminct1.” The example role account also includes a user to add that references the patch engine 121, a user identifier “UID”, a group identifier “GID”, and associated password as well as an administrator user and administrator password. In some embodiments, the role account identifier may be selected from a particular range. For instance, the particular range may be between 200-400. Alternatively, the role account identifier may be simply an unused identifier from a set of potential identifiers.

The role management module 285 may communicate the new role account 260 as the role account 218 to the endpoint 106. Additionally or alternatively, the patch engine 121 may retrieve the new role account 260 using the credentials request 216 or some derivative thereof.

The patch engine 121 may include a decryption module 222 and a patch implementation module 220. The decryption module 222 may be configured to use the retrieved role account 218 to obtain decrypted credentials. The patch implementation module 220 may enter the decrypted credentials to install the product update 224 at the products 115. For instance, entering the decrypted credentials may enable the remediation operation to be executed to implement the product update 224 at the endpoint 106.

A third result may occur when the existing role account 256 is available locally at the endpoint 106. The patch engine 121 may check for the existing role account 256 in the data storage 131 by communicating the role account access request 208. In the third result, the existing role account 256 might be applicable to the endpoint 106 and the products 115 to which the product update 224 is relevant.

The role management module 285 may assess the stored credentials 210, the stored token 212, the existing role account 256, or some combination thereof to ensure the existing role account 256 or another role account generated by the role management module 285 may function to enable the remediation operation at the endpoint 106.

The role management module 285 may validate the stored credentials 210. For instance, the role management module 285 may ensure the stored credentials 210 have not been updated or otherwise expired. Responsive to the stored credentials 210 being invalid, a credentials update request may be communicated. The credentials update request may ask the user 113 to be re-entered.

Additionally, the role management module 285 may determine whether a user associated with the stored credentials 210 includes or has been assigned the stored token 212. Responsive to the stored token 212 not being correctly associated with the stored credentials 210, a secure token administrative request may be communicated. The secure token administrative request may be communicated to the administrator 112 or the vendor device 151 to retrieve an updated secure token (e.g., the secure token 202).

Following receipt of updated credentials and/or an additional secure token, the role management module 285 may generate the new role account 260. Alternatively, if the stored credentials 210 are valid and the stored token 212 is associated with the user, then the role management module 285 may generate the new role account 260. The new role account 260 may be retrieved and used to execute the remediation operation as described above.

The role management module 285 may determine whether the existing role account 256 is functional. For instance, the stored token 212 may be expired or changed, the existing role account 256 may not be associated with the product 115 to which the product update 224 is relevant, etc. Responsive to a determination that the existing role account 256 does not function, the role management module 285 may delete the existing role account 256 and generate the new role account 260 as described elsewhere in the present disclosure. The new role account 260 may be retrieved and used to execute the remediation operation. Responsive to the existing role account 256 being functional, the existing role account 256 may be retrieved by the patch engine 121, which is represented by the role account 218. As described above, decrypted credentials may be obtained from the existing role account 256 (the role account 218). The remediation operation may be executed by entering the decrypted credentials to implement the product update 224.

FIG. 4 depicts an example remediation process 400 based on role account generation that may be implemented in the operating environment 100 of FIG. 1 or another suitable environment. The remediation process 400 may be an example of the role account management process 200B described with reference to FIG. 2C. In FIG. 4, the remediation process 400 is described with reference to a device credentials UI 446, a role manager UI 448, and the patch engine 121. A set of steps taken in each of the device credentials UI 446, the role manager UI 448, and the patch engine 121 are depicted in FIG. 4. Although not depicted in FIG. 4, communication in the remediation process 400 may be via a network such as the network 108. In some embodiments, at least some of the communication in the remediation process 400 may be within a single device and between components thereof without use of an external network.

As described with reference to FIGS. 1 and 2C, the patch engine 121 may be implemented in the endpoint 106. Alternatively, the patch engine 121 may be hosted, at least partially, on a remote system such as the remote management device 104. In these and other embodiments, the patch engine 121 may be implemented at least partially by the patch management engine 107.

One or both of the device credentials UI 446 and the role manager UI 448 may be implemented at a managed endpoint such as the endpoint 106 or another endpoint of a managed network (e.g., 110 of FIG. 1). The device credentials UI 446 and the role manager UI 448 may interface with users to display information and data and to receive user input to modules or systems implementing the remediation process 400 and/or the role account management process 200B. The patch engine 121, the device credentials UI 446, the role manager UI 448, or any combination thereof may be implemented on a single managed endpoint or at least partially at a remote management device such as the remote management device 104 of FIGS. 1 and 2C. Alternatively, the patch engine 121, the device credentials UI 446, the role manager UI 448 may be implemented on separate managed endpoints or some combination of managed endpoints and remote management devices(s).

The remediation process 400 of FIG. 4 depicts multiple sequences of operations. A first sequence may begin at block 408 at the patch engine 121 in which a remote management system requests patches to be installed (block 408). A request may be communicated to the patch engine 121, which may be included at a managed endpoint (e.g., the endpoint 106) in some embodiments. At block 410, the patch engine 121 scans and reports patches that are needed. At block 412, the patch engine 121 checks for an existing role account in a secured data storage such as data storage 131 of FIGS. 1 and 2C. If the credentials are not available, the remediation process 400 may proceed to block 418.

At block 418, the patch engine 121 may trigger a credentials request to ask for an admin user's credentials to generate a role account. The credentials request may be communicated to the device credentials UI 446 and/or to the role manager UI 448. For example, the credentials request may be triggered in the role manager UI 448, which is depicted in block 434. At block 434, the role manager UI 448 requests credentials entry. At block 436, a user enters credentials. At block 432, a role manager module or another system may check a user to determine whether the user has a secure token and credentials that are valid. If the user has a secure token and credentials are valid, then the remediation process 400 may proceed to block 422. At block 422, a user clicks “OK” or another icon indicating a confirmation by a user in the role manager UI to generate the new role account. At block 420, an application initiates instructions to generate a new role account. The new role account may have a secured password. After the new role account is generated, it may be stored in the secured data storage and made available to the patch engine 121. The remediation process 400 may proceed to block 440. At block 440, credentials are successfully retrieved from the secured data storage. At block 416, the patch engine 121 enters decrypted credentials from the role account and executes the remediator, which deploys the patches to be installed.

A second sequence may begin at block 408 at the patch engine 121 in which a remote management system requests patches to be installed (block 408). At block 410, the patch engine 121 scans and reports patches that are needed. At block 412, the patch engine 121 checks for an existing role account in the secured data storage. If the existing role account is available, the remediation process 400 may proceed to block 440. At block 440, the existing role account is successfully retrieved from the secured data storage. At block 416, the patch engine 121 uses decrypted credentials from the role account and executes the remediator, which deploys the patches to be installed.

A third sequence may begin at block 408 at the patch engine 121 in which a remote management system requests patches to be installed (block 408). At block 410, the patch engine 121 scans and reports patches that are needed. At block 412, the patch engine 121 checks for credentials in a secured data storage. If the existing role account is not available, then the remediation process 400 may proceed to block 418.

At block 418, the patch engine 121 may trigger a credentials request to ask for an admin user's credentials to generate a role account. The credentials request may be communicated to the device credentials UI 446 and/or to the role manager UI 448. For example, the credentials request may be triggered in the role manager UI 448, which is depicted in block 434. At block 434, the role manager UI 448 requests credentials entry. At block 436, a user enters credentials. At block 432, a role manager module or another system may check a user to determine whether the user has a secure token and credentials that are valid. From block 432, the remediation process 400 may proceed to either blocks 424 or 426. At block 424, if the user does not have a secure token, the remediation process 400 may include an operation to inform a user to contact system admin. After the secure token is received, the remediation process 400 may proceed to block 422. At block 426, if the credentials are invalid, the remediation process 400 may include an operation to inform the user of invalid credentials. After valid credentials are entered, the remediation process 400 may proceed to blocks 422, 420, 440, and 416 as described above.

A fourth sequence may begin at block 402 in which a user enters device credentials into a remote management system. At block 442, the remote management system passes secure credentials to one or more agents such as the agent 123 of FIGS. 1 and 2. At block 444, the device credentials UI 446 detects credentials. The remediation process 400 may proceed to block 406. At block 406, if credentials exist, attempt to create a role account. For instance, the remediation process 400 may proceed to blocks 432 (optionally 424 and 426), 422, and 420. The role account generated at block 420 may then be available if the user has the secure token and the credentials are valid. The fourth sequence may then move to blocks 408, 410, and 412. The role account generated earlier may be available. Accordingly, the fourth sequence may proceed to blocks 440 and 416.

A fifth sequence may begin at block 402, then proceed to block 442 and 444. The remediation process 400 may proceed to block 434 if credentials do not exist in the secured data storage. The fifth sequence of the remediation process 400 may then proceed through blocks 434, 436, 432 (optionally 424 and 426), 422, and 420. The role account generated at block 420 may then be available. The fifth sequence may then move to blocks 408, 410, and 412. The role account generated earlier may be available. Accordingly, the fifth sequence may proceed to blocks 440 and 416.

In the fourth and fifth sequences, at block 412 when the patch engine 121 checks for credentials in the secured data storage, the remediation process 400 may proceed to blocks 428 and 430. At block 428, if the role account already exists, then it may be determined whether the credentials in the secured data storage are valid. At block 430, if the role credentials do not work, then the role account may be deleted and a new role account may be created. Following block 430, the remediation process 400 may proceed to blocks 440 and 416 (as described above) if the credentials are valid and the role credentials work. However, if the credentials in the secured data storage are invalid and/or the role account does not function, the remediation process 400 may proceed to either blocks 418, 434, 436, 432, 422, 420, or some portion thereof to generate a new role account.

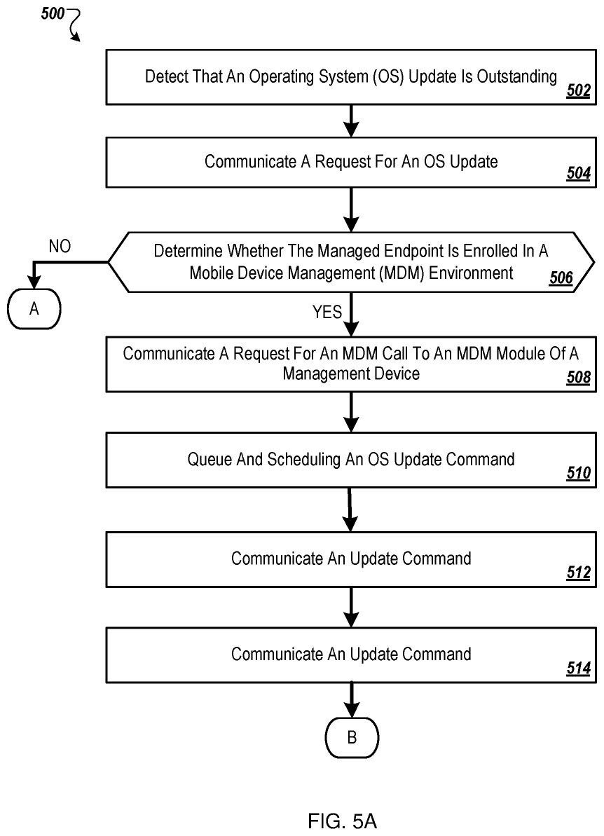

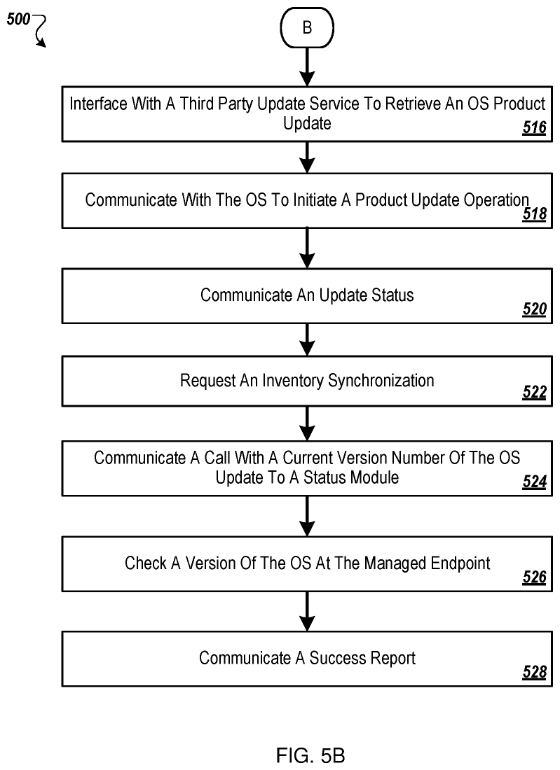

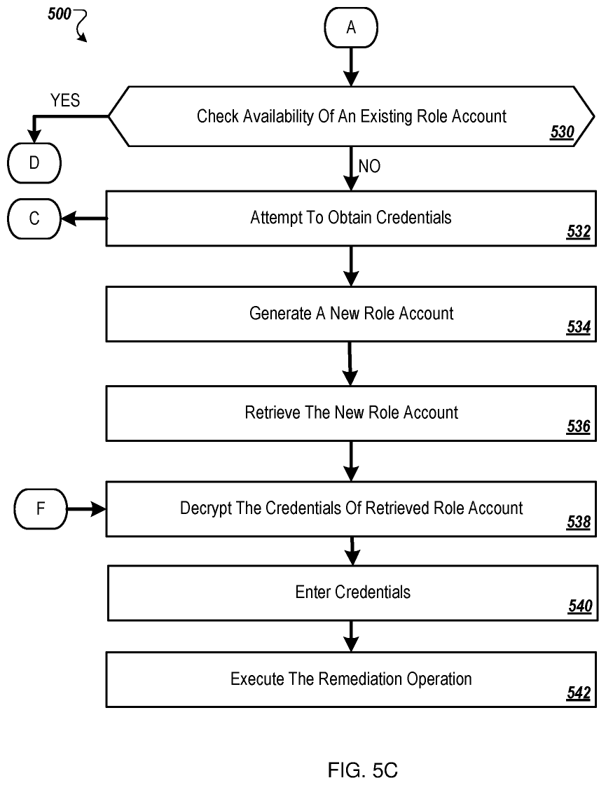

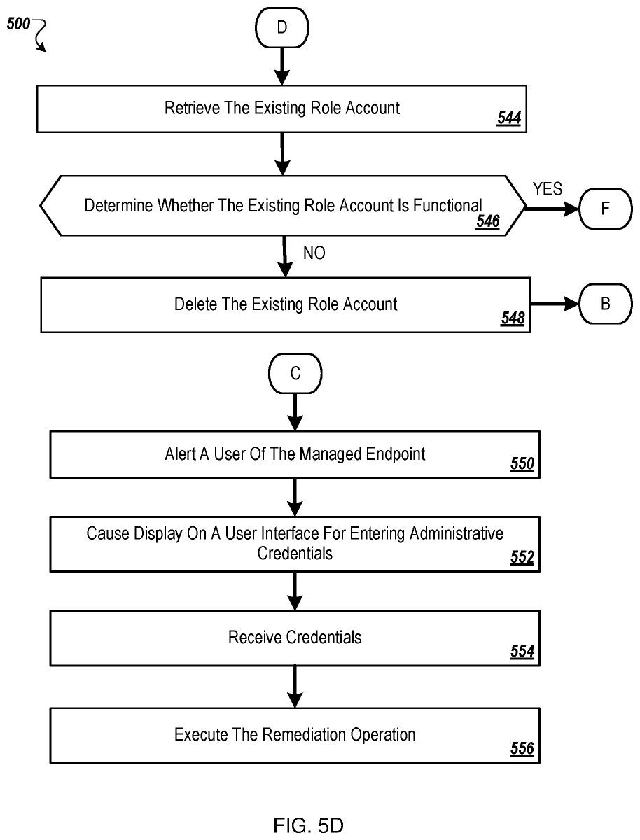

FIGS. 5A-5D are a flow chart of an example method 500 of product update management, according to at least one embodiment of the present disclosure. The method 500 may be implemented in systems and devices having product access restrictions associated with administrative credentials. For example, the method 500 may be implemented in Apple devices (e.g., endpoints 106) or devices that implement an Apple operating system such as macOS.

Referring to FIG. 5A, the method 500 may begin at block 502 in which an operating system (OS) update may be detected that is outstanding. The OS update may be for an OS at a managed endpoint. At block 504, a request for an OS update may be communicated. The request may be communicated to the managed endpoint. At block 506, it may be determined whether the managed endpoint is enrolled in a mobile device management (MDM) environment. In response to a determination that the managed endpoint is enrolled in the MDM environment (“YES” at block 506), the method 500 may proceed to block 508. In response to a determination that the managed endpoint is not enrolled in the MDM environment (“NO” at block 506), the method 500 may proceed to block 530.

At block 508, a request for an MDM call may be communicated. The MDM call may be communicated to an MDM module of a management device. In some embodiments, the MDM module may include authority to initiate the OS update at the managed endpoint. At block 510, an OS update command may be queued and scheduled. The OS update command may be queued and scheduled with an MDM requester. At block 512, an update command may be communicated. The update command may be communicated by the MDM requester and to a vendor agent of the managed endpoint.

Referring to FIG. 5B, at block 516, a third party update service may be interfaced with. The third party update service may be interfaced with to retrieve an OS product update. At block 518, the OS may be communicated with. The OS may be communicated with to initiate a product update operation. The product update operation is implemented to modify the OS at the managed endpoint to install the OS product update. At block 520, an update status may be communicated. The update status may be communicated to a vulcore endpoint at the management device. In some embodiments, the update status may include a success message or an error message of the product update operation. The update status may be assessed and communicated by an agent at the managed endpoint. At block 522, an inventory synchronization may be requested. The inventory synchronization may be requested by a vendor agent with a mobile sync module of the managed endpoint. At block 524, a call may be communicated. The call may be communicated to the mobile sync module. The call may include a current version number of the OS update. The call may be communicated to the status module.

At block 526, a version of the OS at the managed endpoint may be checked. In some embodiments, the version check may include verifying a version of a pending OS update includes an equal or lower version number than a current version at the managed endpoint. At block 528, a success report may be communicated. The success report may be communicated to a vulcore endpoint. The success report may be communicated in response to the version of the pending OS update being the equal or lower version number than the current version at the managed endpoint.

At block 530, availability of an existing role account may be checked. In systems and networks implementing the method 500, the existing role account may enable a remediation operation including the installation or implementation of the product update. For instance, in these and other systems and networks, modifications to products may be prevented without the existing role account that comprises administrative authority and a secure token assigned to an administrator. Without the existing role account, attempted installation of the product update at the managed endpoint results in an error message. In some embodiments, the checking availability of the existing role account includes accessing a secured data storage, which may be implemented on the managed endpoint. The secured data storage may include a password management system such as keychain. In these and other embodiments, a patch engine on the managed endpoint may attempt to access the existing role account from the keychain.

In response to the existing role account being available (“YES” at block 530), the method 500 may proceed to block 544 of FIG. 5D. In response to the existing role account being unavailable (“NO” at block 530), the method 500 may proceed to block 532.

At block 532, obtaining credentials may be attempted. The existing role account may be obtained that are associated with a user who is authorized to enable the remediation operation. In some embodiments, obtaining the credentials may include triggering a credentials request. The credentials request may be triggered in a role manager user interface. The credentials request may initiate or cause display of a window to a user of the managed endpoint into which the credentials may be entered.

At block 534, a new role account may be generated. Generation of the new role account may be enabled by the obtained credentials. The new role account is configured to enable the remediation operation. Additionally, the new role account may include a secured password. The secured password may be configured to secure the new role account in the secured data storage. For instance, in some embodiments, the new role account may include reference to user credentials of a user of the managed endpoint, administrator user credentials, a role account identifier, the secured password, other information to enable the remediation operation, or combinations thereof.

At block 536, the role account may be retrieved. For example, the role account may be retrieved from the secured data storage. At block 538, the credentials may be decrypted. The credentials may be included in the retrieved role account. At block 540, the credentials may be entered. In embodiments in which the credentials are decrypted, the decrypted credentials may be entered. Entry of the credentials from the retrieved role account may enable the remediation operation to be performed. At block 542, the remediation operation may be executed. The remediation operation may be executed to implement the product update at the managed endpoint. Implementation of the product update may modify a state or a setting of the managed endpoint. For instance, the product update may include installation of an updated version of the product and removal of a previous version (substantially similar to operations at block 518).

Referring to FIG. 5D, at block 544, the existing role account may be retrieved. The existing role account may be retrieved in response to the existing role account being available (“YES” at block 530). In some embodiments, the existing role account may be retrieved from the secured data storage at the managed endpoint.

At block 546, it may be determined whether the existing role account is functional. For instance, between a previous product update and the receipt of the installation request credentials and/or a token may have been updated or changed. Accordingly, the existing role account may be non-functional. In circumstances in which the existing role account is non-functional, an error may be generated when the exiting role account is used to attempt to perform the remediation operation. In contrast, if the credentials and the token have not been updated or changed, the exiting role account may be functional to implement the product update that is outstanding for the product.

Responsive to the existing role account being functional, (“YES” at block 546), the method 500 may proceed to block 538 of FIG. 5C. In block 538, the credentials of the existing role account may be decrypted and entered to execute the remediation operation of block 542. Responsive to the existing role account not being functional, (“NO” at block 546), the method 500 may proceed to block 548. At block 548, the non-functional existing role account may be deleted. The method 500 may proceed to block 530 of FIG. 5C.

Referring to FIG. 5D, the method 500 may proceed to block 550 in response to the attempt to obtain the credentials being unsuccessful (e.g., the operations of block 532). Accordingly, the method 500 may be performed in response to the managed endpoint not being included in the MDM environment and the role account not being able to be obtained. At block 550, a user of the managed endpoint may be alerted. In some embodiments, the alert is initiated by the agent.

The user may be alerted that an update to the OS is outstanding. At block 552, display of a user interface may be caused. The user interface may be implemented to enable entry of administrative credentials to enable remediation of the update to the OS. The user interface may be displayed on the managed endpoint. At block 554, credentials may be received. The credentials may be of a user that has authority to implement the OS update. The credentials may be received via the user interface. At block 556, the remediation operation may be executed. The remediation operation may be executed using the credentials.

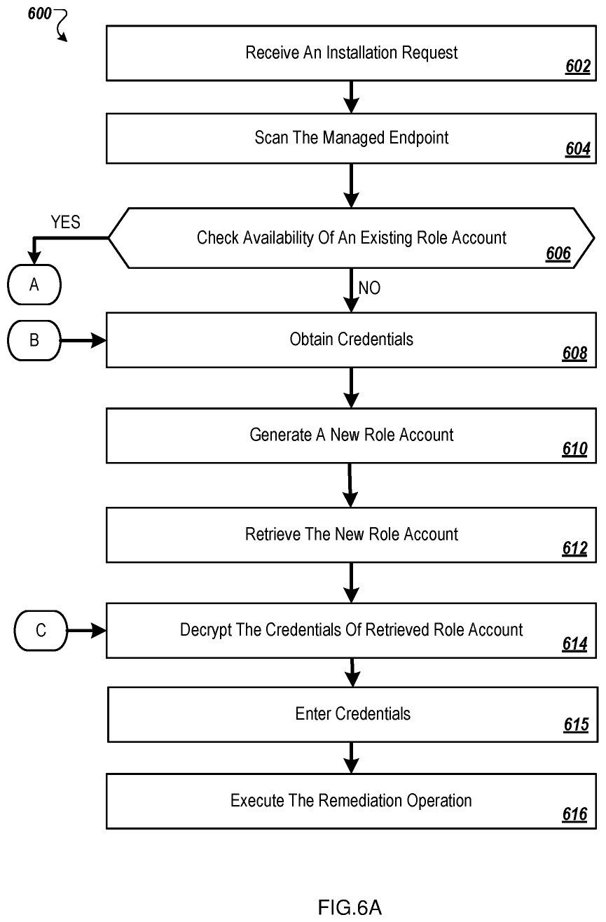

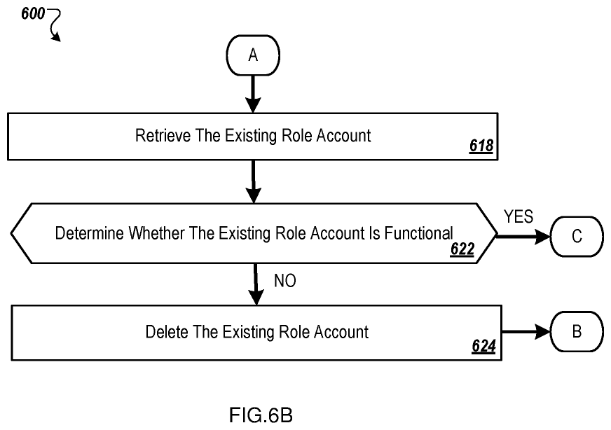

FIGS. 6A and 6B are a flow chart of an example method 600 of product update management, according to at least one embodiment of the present disclosure. The method 600 may be implemented in systems and devices having product access restrictions associated with administrative credentials. For example, the method 600 may be implemented in Apple devices (e.g., endpoints 106) or devices that implement an Apple operating system such as macOS.

The method may begin at block 602 in which an installation request is received. The installation request may be received for a product update to a product associated with a managed endpoint. In some embodiments, the installation request is generated and communicated by a remote management system. The installation request may be responsive to an update notification. The update notification may indicate that a new version of the product is published, a vulnerability exists at the product, or a malfunction of the product has been corrected. The update notification may be associated with the update such as a patch or the new version of the product as well as metadata associated with the product update. The installation request may be received from a remote management device. For instance, the managed endpoint may be included in a managed network that implements a patch management service. The patch management service may monitor for the update notification and generate update packages configured to implement the update at endpoints.

At block 604, the managed endpoint may be scanned. The managed endpoint may be scanned to ensure the product update is relevant to the product installed at the managed endpoint. For instance, the scan may assess whether the product update is applicable to a version of the product that is installed at the managed endpoint at a time in which the installation request is received. The scan may be based on the metadata associated with the update and may be implemented based on an update package generated for the product. For instance, the scan may access product information at the managed endpoint such as metadata indicative of a version of the product. The scan may then verify that the product update is applicable to the version of the product.

At block 606, availability of an existing role account may be checked. In systems and networks implementing the method 600, the existing role account may enable a remediation operation including the installation or implementation of the product update. For instance, in these and other systems and networks, modifications to products may be prevented without the existing role account that comprises administrative authority and a secure token assigned to an administrator. Without the existing role account, attempted installation of the product update at the managed endpoint results in an error message. In some embodiments, the checking availability of the existing role account includes accessing a secured data storage, which may be implemented on the managed endpoint. The secured data storage may include a password management system such as keychain. In these and other embodiments, a patch engine on the managed endpoint may attempt to access the existing role account from the keychain.

In response to the existing role account being available (“YES” at block 606), the method 600 may proceed to block 618 of FIG. 6B. In response to the existing role account being unavailable (“NO” at block 606), the method 600 may proceed to block 608.

At block 608, credentials may be obtained. The existing role account may be obtained that are associated with a user who is authorized to enable the remediation operation. In some embodiments, obtaining the credentials may include triggering a credentials request. The credentials request may be triggered in a role manager user interface. The credentials request may initiate or cause display of a window to a user of the managed endpoint into which the credentials may be entered.

At block 610, a new role account may be generated. Generation of the new role account may be enabled by the obtained credentials. The new role account is configured to enable the remediation operation. Additionally, the new role account may include a secured password. The secured password may be configured to secure the new role account in the secured data storage. For instance, in some embodiments, the new role account may include reference to user credentials of a user of the managed endpoint, administrator user credentials, a role account identifier, the secured password, other information to enable the remediation operation, or combinations thereof.

In some embodiments, the new role account may be generated according to an instruction:

sudo sysadminct1−addUser “AgentName”−roleAccount−UID<id>−GID<gid>−password<pass>interactive.

In some embodiments, the new role account may be stored after it is generated. For instance, the new role account may be stored in the secured data storage such that it may be accessed by the managed endpoint. In some embodiments, the new role account may be generated locally at the managed endpoint. In these and other embodiments, the new role account and the secured password may be generated as a background process. Additionally, the new role account and the secured password may be securely passed to the secured data storage such that new role account and the secured password are not visible and not accessible by a user of the managed endpoint. Accordingly, generation of the new role account may only involve entry of the credentials by the user of the managed endpoint. The user of the managed endpoint may not see or be aware of the background process that generates the new role account.

At block 612, the role account may be retrieved. For example, the role account may be retrieved from the secured data storage. At block 614, the credentials may be decrypted. The credentials may be included in the retrieved role account. At block 615, the credentials may be entered. In embodiments in which the credentials are decrypted, the decrypted credentials may be entered. Entry of the credentials from the retrieved role account may enable the remediation operation to be performed. At block 616, the remediation operation may be executed. The remediation operation may be executed to implement the product update at the managed endpoint. Implementation of the product update may modify a state or a setting of the managed endpoint. For instance, the product update may include installation of an updated version of the product and removal of a previous version.

Referring to FIG. 6B, at block 618, the existing role account may be retrieved. The existing role account may be retrieved in response to the existing role account being available (“YES” at block 606). In some embodiments, the existing role account may be retrieved from the secured data storage at the managed endpoint.

At block 622, it may be determined whether the existing role account is functional. For instance, between a previous product update and the receipt of the installation request (of block 602) credentials and/or a token may have been updated or changed. Accordingly, the existing role account may be non-functional. In circumstances in which the existing role account is non-functional, an error may be generated when the exiting role account is used to attempt to perform the remediation operation. In contrast, if the credentials and the token have not been updated or changed, the exiting role account may be functional to implement the product update that is outstanding for the product.

Responsive to the existing role account being functional, (“YES” at block 620), the method 600 may proceed to block 614 of FIG. 6A. In block 614, the credentials of the existing role account may be decrypted and entered to execute the remediation operation of block 616. Responsive to the existing role account not being functional, (“NO” at block 620), the method 600 may proceed to block 624. At block 624, the non-functional existing role account may be deleted. The method 600 may proceed to block 608 of FIG. 6A. From block 608, the method 600 may proceed through block 610, 612, 614, 616, etc. or some combinations thereof. For instance, the new role account may be generated (in block 610) responsive to the existing role account not functioning.

Modifications, additions, or omissions may be made to the method 600 without departing from the scope of the present disclosure. For example, in some embodiments prior to the installation request for the product update, the credentials may be received by a remote management system. The credentials may then be distributed to a local engine at the managed endpoint or stored at a remote storage location such that the credentials are remotely accessible by the local engine. In these and other embodiments, a role account may be generated according to a second example role account generation instruction:

sudo sysadminct1−addUser “AgentName”−roleAccount−UID<id>−GID<gid>−password<pass>.

The second example role account generation instruction includes substantially similar commands and identifiers as the first example role account generation instruction.

In these and other embodiments, the method 600 may include determining whether a user associated with the credentials has authority to perform the remediation operation. In some embodiments, the authority may be indicated by the user associated with the credentials being assigned a secure token, by the user having administrative credentials, by the user being designated as a volume owner. The role account may be generated (e.g., as in block 610) responsive to the user having such authority. The new role account may become an existing role account or may be may available to the managed endpoint for performance of one or more additional remediation operations.

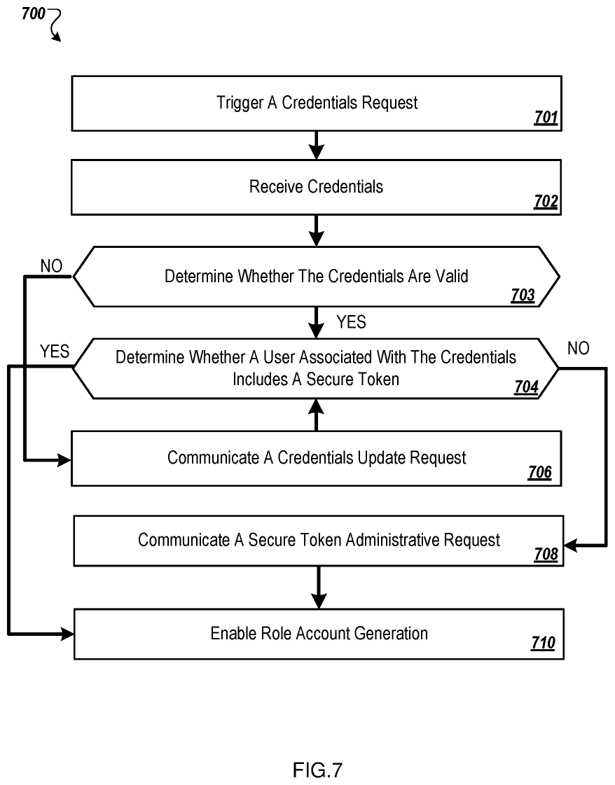

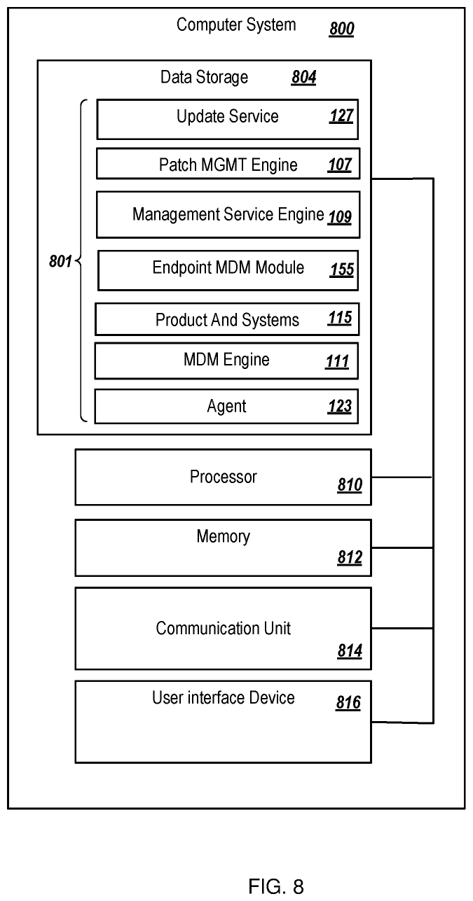

FIG. 7 is a flow chart of an example method 700 of obtaining credentials, according to at least one embodiment of the present disclosure. The method 700 may be performed as part of another method. For instance, the method 700 may be performed as part of the operations of block 608 of the method 600 of FIGS. 6A and 6B.

The method 700 may begin at block 701 in which a credentials request may be triggered. The credentials request may be triggered in a role manager user interface, which may be implemented in a managed endpoint. The credentials request may be a request for credentials associated with a user who is authorized to enable a remediation operation or more generally administrative operations on the managed endpoint. At block 702, credentials may be received. The credentials may be received responsive to the credentials request. In some embodiments, the user may enter the credentials into the role manager user interface.

The method 700 may proceed through one or more of block 703, 704, 706, 708 to perform a check of the credentials as well as the authority of the user associated with the credentials. In particular, the method 700 may be implemented to ensure the credentials are valid and the user associated with the credentials has been assigned as valid secure token. For instance, at block 703, it may be determined whether the credentials are valid. In some embodiments, validity of the credentials may ensure that the user is uniquely associated with the received credentials and that the credentials are current in a system implemented to manage the managed endpoint.

In response to the credentials being valid (“YES” at block 703), the method may proceed to block 704. In response to the credentials not being valid (“NO” at block 703), the method may proceed to block 706. At block 706, a credentials update request may be generated and communicated. The credentials update request may request the user changes their password, username, two-factor authentication, etc. After the credentials are validated, the method 700 may proceed to block 704.

At block 704, it may be determined whether the user associated with the credentials includes or has been assigned a secure token. The secure token may be communicated from a vendor. For instance, the secure token may be communicated when the managed endpoint is purchased or incorporated in a managed network. In response to the credentials not including the secure token (“NO” at block 704), the method may proceed to block 708. In response to the credentials including the secure token (“YES” at block 704), the method may proceed to block 710.

At block 708, a secure token administrative request may be generated and communicated. For instance, the user associated with the received credentials may not have been assigned a secure token. In response, the secure token administrative request may be communicated to an administrator of a secured network to obtain the secure token. After the secure token is received, the method 700 may proceed to block 710. At block 710, role account generation may be enabled. The role account generation may be enabled based on the credentials and the secure token. For instance, the role account generation may be performed as discussed with reference to block 610 of FIG. 6A.

The methods 500, 600, and 700 may be performed in a suitable operating environment such as the operating environment 100 of FIG. 1. The methods 500, 600, and 700 may be performed by the remote management device 104 described elsewhere in the present disclosure or by another suitable computing system, such as the computer system 800 of FIG. 8. In some embodiments, the remote management device 104 or the other computing system may include or may be communicatively coupled to a non-transitory computer-readable medium (e.g., the memory 812 of FIG. 8) having stored thereon programming code or instructions that are executable by one or more processors (such as the processor 810 of FIG. 8) to cause a computing system or the remote management device 104 to perform or control performance of the methods 500, 600, and 700. Additionally or alternatively, the remote management device 104 may include the processor 810 that is configured to execute computer instructions to cause the remote management device 104 or another computing systems to perform or control performance of the methods 500, 600, and 700. The remote management device 104 or the computer system 800 implementing the methods 500, 600, and 700 may be included in a cloud-based managed network, an on-premises system, or another suitable network computing environment. Although illustrated as discrete blocks, one or more blocks in FIGS. 5A-7 may be divided into additional blocks, combined into fewer blocks, or eliminated, depending on the desired implementation.

Further, modifications, additions, or omissions may be made to the methods 500, 600, and 700 without departing from the scope of the present disclosure. For example, the operations of the method 500 may be implemented in differing order. Furthermore, the outlined operations and actions are only provided as examples, and some of the operations and actions may be optional, combined into fewer operations and actions, or expanded into additional operations and actions without detracting from the disclosed embodiments.

FIG. 8 illustrates an example computer system 800 configured for product update management in systems having product access restrictions, according to at least one embodiment of the present disclosure. The computer system 800 may be implemented in the operating environment 100 of FIG. 1, for instance. Examples of the computer system 800 may include the remote management device 104, the endpoint 106, the vendor device 151, or some combination thereof. The computer system 800 may include one or more processors 810, a memory 812, a communication unit 814, a user interface device 816, and a data storage 804 that includes the update service 127, the patch management engine 107, the management service engine 109, the endpoint MDM module 155, the products 115, the MDM engine 111, the agent 123, or some combination thereof (collectively modules 801) configured for product update management.

The processor 810 may include any suitable special-purpose or general-purpose computer, computing entity, or processing device including various computer hardware or software modules and may be configured to execute instructions stored on any applicable computer-readable storage media. For example, the processor 810 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 8, the processor 810 may more generally include any number of processors configured to perform individually or collectively any number of operations described in the present disclosure. Additionally, one or more of the processors 810 may be present on one or more different electronic devices or computing systems. In some embodiments, the processor 810 may interpret and/or execute program instructions and/or process data stored in the memory 812, the data storage 804, or the memory 812 and the data storage 804. In some embodiments, the processor 810 may fetch program instructions from the data storage 804 and load the program instructions in the memory 812. After the program instructions are loaded into the memory 812, the processor 810 may execute the program instructions.

The memory 812 and the data storage 804 may include computer-readable storage media for carrying or having computer-executable instructions or data structures stored thereon. Such computer-readable storage media may include any available media that may be accessed by a general-purpose or special-purpose computer, such as the processor 810. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 810 to perform a certain operation or group of operations.

The communication unit 814 may include one or more pieces of hardware configured to receive and send communications. In some embodiments, the communication unit 814 may include one or more of an antenna, a wired port, and modulation/demodulation hardware, among other communication hardware devices. In particular, the communication unit 814 may be configured to receive a communication from outside the computer system 800 and to present the communication to the processor 810 or to send a communication from the processor 810 to another device or network (e.g., 108 of FIG. 1).

The user interface device 816 may include one or more pieces of hardware configured to receive input from and/or provide output to a user. In some embodiments, the user interface device 816 may include one or more of a speaker, a microphone, a display, a keyboard, a touch screen, or a holographic projection, among other hardware devices.

The modules 801 may include program instructions stored in the data storage 804. The processor 810 may be configured to load the modules 801 into the memory 812 and execute the modules 801. Alternatively, the processor 810 may execute the modules 801 line-by-line from the data storage 804 without loading them into the memory 812.

Modifications, additions, or omissions may be made to the computer system 800 without departing from the scope of the present disclosure. For example, in some embodiments, the computer system 800 may not include the user interface device 816. In some embodiments, the different components of the computer system 800 may be physically separate and may be communicatively coupled via any suitable mechanism. For example, the data storage 804 may be part of a storage device that is separate from a device, which includes the processor 810, the memory 812, and the communication unit 814, that is communicatively coupled to the storage device. The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the embodiments and the concepts contributed to furthering the art and are to be construed as being without limitation to such specifically recited examples and conditions. Although embodiments have been described in detail, various changes, substitutions, and alterations could be made hereto without departing from the scope of the embodiments.

What is claimed is:

1. A method of product update management in systems having product access restrictions associated with administrative credentials, the method comprising:
detecting that an operating system (OS) update is outstanding for an OS at a managed endpoint;
communicating a request for an OS update to the managed endpoint;
determining whether the managed endpoint is enrolled in a mobile device management (MDM) environment;
in response to a determination that the managed endpoint is enrolled in the MDM environment, communicating a request for an MDM call to an MDM module of a management device, wherein the MDM module includes authority to initiate the OS update at the managed endpoint;
queuing and scheduling an OS update command with an MDM requester;
communicating, by the MDM requester, an update command to a vendor agent of the managed endpoint;
interfacing with a third party update service to retrieve an OS product update; and
communicating with the OS to initiate a product update operation, wherein the product update operation is implemented to modify the OS at the managed endpoint to install the OS product update.

2. The method of claim 1, further comprising communicating an update status to a vulcore endpoint at the management device.

3. The method of claim 2, wherein:
the update status includes a success message or an error message of the product update operation; and
the update status is assessed and communicated by an agent at the managed endpoint.

4. The method of claim 1, further comprising:
requesting a vendor agent for an inventory synchronization with a mobile sync module of the managed endpoint; and
communicating to the mobile sync module a call with a current version number of the OS update to a status module.

5. The method of claim 1, further comprising:
checking a version of the OS at the managed endpoint, wherein the checking the version includes verifying a version of a pending OS update includes an equal or lower version number than a current version at the managed endpoint; and
communicating a success report to a vulcore endpoint in response to the version of the pending OS update being the equal or lower version number than the current version at the managed endpoint.

6. The method of claim 1, further comprising:
in response to a determination that the managed endpoint is not enrolled in the MDM environment:
checking availability of an existing role account that enables a remediation operation at the managed endpoint;
in response to the existing role account being unavailable:
attempting to obtain credentials of a user authorized to enable the remediation operation;
in response to the credentials being obtained, generating a new role account configured to enable the remediation operation, wherein generation of the new role account is enabled by the obtained credentials and includes a secured password;
storing the new role account in a secured data storage at the managed endpoint;
retrieving the new role account from the secured data storage;
entering the credentials from the retrieved role account; and
executing the remediation operation to implement the OS product update at the managed endpoint.

7. The method of claim 6, wherein the new role account and the secured password are generated as a background process and securely passed to the secured data storage such that new role account and the secured password are not visible and not accessible by a user of the managed endpoint.

8. The method of claim 6, wherein the secured data storage includes a password management system on the managed endpoint.

9. The method of claim 6, in response to the attempt to obtain the credentials being unsuccessful:
alerting a user of the managed endpoint that an update to the OS is outstanding; and
causing display on a user interface for entering administrative credentials on the managed endpoint to enable remediation of the update to the OS.

10. The method of claim 9, wherein the alert is initiated by the agent.

11. A non-transitory computer-readable medium having encoded therein programming code executable by one or more processors to perform or control performance of operations of product update management in systems having product access restrictions associated with administrative credentials, the operations comprising:
detecting that an operating system (OS) update is outstanding for an OS at a managed endpoint;
communicating a request for an OS update to the managed endpoint;
determining whether the managed endpoint is enrolled in a mobile device management (MDM) environment;
in response to a determination that the managed endpoint is enrolled in the MDM environment, communicating a request for an MDM call to an MDM module of a management device, wherein the MDM module includes authority to initiate the OS update at the managed endpoint;
queuing and scheduling an OS update command with an MDM requester;
communicating, by the MDM requester, an update command to a vendor agent of the managed endpoint;
interfacing with a third party update service to retrieve an OS product update; and
communicating with the OS to initiate a product update operation, wherein the product update operation is implemented to modify the OS at the managed endpoint to install the OS product update.

12. The non-transitory computer-readable medium of claim 11, wherein the operations further comprise communicating an update status to a vulcore endpoint at the management device.

13. The non-transitory computer-readable medium of claim 12, wherein:
the update status includes a success message or an error message of the product update operation; and
the update status is assessed and communicated by an agent at the managed endpoint.

14. The non-transitory computer-readable medium of claim 11, wherein the operations further comprise:
requesting a vendor agent for an inventory synchronization with a mobile sync module of the managed endpoint; and
communicating to the mobile sync module a call with a current version number of the OS update to a status module.

15. The non-transitory computer-readable medium of claim 11, wherein the operations further comprise:
checking a version of the OS at the managed endpoint, wherein the checking the version includes verifying a version of a pending OS update includes an equal or lower version number than a current version at the managed endpoint; and
communicating a success report to a vulcore endpoint in response to the version of the pending OS update being the equal or lower version number than the current version at the managed endpoint.

16. The non-transitory computer-readable medium of claim 11, wherein the operations further comprise:
in response to a determination that the managed endpoint is not enrolled in the MDM environment:
checking availability of an existing role account that enables a remediation operation at the managed endpoint;
in response to the existing role account being unavailable:
attempting to obtain credentials of a user authorized to enable the remediation operation;
in response to the credentials being obtained, generating a new role account configured to enable the remediation operation, wherein generation of the new role account is enabled by the obtained credentials and includes a secured password;
storing the new role account in a secured data storage at the managed endpoint;
retrieving the new role account from the secured data storage;
entering the credentials from the retrieved role account; and
executing the remediation operation to implement the OS product update at the managed endpoint.

17. The non-transitory computer-readable medium of claim 16, wherein the new role account and the secured password are generated as a background process and securely passed to the secured data storage such that new role account and the secured password are not visible and not accessible by a user of the managed endpoint.

18. The non-transitory computer-readable medium of claim 16, wherein the secured data storage includes a password management system on the managed endpoint.

19. The non-transitory computer-readable medium of claim 16, wherein the operations further comprise in response to the attempt to obtain the credentials being unsuccessful:
alerting a user of the managed endpoint that an update to the OS is outstanding; and
causing display on a user interface for entering administrative credentials on the managed endpoint to enable remediation of the update to the OS.

20. The non-transitory computer-readable medium of claim 19, wherein the alert is initiated by the agent.
